(19) United States
(12) Patent Application Publication
(10) Pub. No.: US 2023/0384454 A1
(43) Pub. Date: Nov. 30, 2023

(54) METHOD, APPARATUS, AND SYSTEM FOR MAPPING AND LEVERAGING USAGE DATA OF LIDAR ON MOBILE DEVICES

(71) Applicant: HERE Global B.V., Eindhoven (NL)

(72) Inventors: Jerome BEAUREPAIRE, Nantes (FR); Lauri Aarne Johannes WIROLA, Tampere (FI); Eckhart KÖPPEN, Tampere (FI)

(21) Appl. No.: 17/825,883

(22) Filed: May 26, 2022

(51) Int. Cl. G01S 17/89

(52) U.S. Cl. CPC G01S 17/89

(57) ABSTRACT

An approach is provided for generating and leveraging map layer(s) representing information associated with Light Detection and Ranging (LiDAR) usage on mobile devices. The approach, for instance, involves determining LiDAR usage data generated by one or more mobile devices. The approach also involves generating a map layer of a geographic database based on the LiDAR usage data. The map layer indicates one or more locations where a LiDAR device was used by the one or more mobile devices based on the LiDAR usage data. The approach further involves providing the map layer as an output.

### BACKGROUND

Mapping service providers are continually challenged to provide compelling navigation services. One area of development for mapping and navigation services providers is in the area of localization of mobile devices, especially when satellite positioning signals such as those based on the Global Positioning System (GPS) or any other equivalent Global Navigation Satellite system (GNSS) are unavailable (e.g., when users traveling in a subway station, indoors, etc.). In recent years, Light Detection and Ranging (LiDAR) became major localization-assistance sensors for automated vehicles, and LiDAR is also used to provide continuous navigation for indoor mobile robotics. As more mobile devices (e.g., smart phones, smart glasses, etc.) are equipped with LiDAR sensors, various approaches are developed to take advantage of LiDAR being more privacy sensitive, more efficient in low-light conditions, faster acquisition, less susceptible to various movements, etc. For instances, LiDAR scans can be used to generate LiDAR location (or path) signatures in spaces for mobile devices to share peer-to-peer and navigate therein. However, there is no platform to organize and manage such information-rich LiDAR location signatures and/or LiDAR usage data such that they can be better understood, optimized, and improved for various location-based use cases.

### SOME EXAMPLE EMBODIMENTS

Therefore, there is a need for technical approaches for mapping and leveraging usage data of LiDAR on mobile devices.

As used herein, the term “LiDAR usage data” refers to the attributes/parameters associated with LiDAR used by mobile device(s) at a location and/or in a geographic area for localization, scanning characteristic recommendations for different environments and/or outcomes, geofence-driven transition among different localization technologies, etc. The attributes/parameters can include but not limited to: location(s) where a LiDAR device was used, a number/duration of LiDAR scans occurred at the location(s), a number of the mobile device(s) performing a LiDAR scan at the location(s), a date or time of LiDAR usage or scanning, a manufacturer, model, type, year, capabilities/features, a manufacturer of a LiDAR sensor used by the mobile device(s), a model of the LiDAR sensor, a type of the LiDAR sensor, one or more capabilities or features of the LiDAR sensor, a manufacturer of the mobile device(s), a model of the mobile device(s), a type of the mobile device(s), one or more capabilities or features of the mobile device(s), a LiDAR-based localization success rate, a type of object detected by a LiDAR scan, a number of scans in a scanning session, a scanning orientation, a moving versus stationary LiDAR scan, contextual information of a scanning environment, etc. Although various embodiments are described with respect to indoor LiDAR usage (including where satellite-based positioning technology (e.g., GNSS) are unavailable and/or potentially compromise privacy), it is contemplated that the approach described herein may be used with outdoor LiDAR usage.

According to one embodiment, a method comprises determining, by one or more processors, Light Detection and Ranging (LiDAR) usage data generated by one or more mobile devices. The method also comprises generating, by the one or more processors, a map layer of a geographic database based on the LiDAR usage data. The map layer indicates one or more locations where a LiDAR device was used by the one or more mobile devices based on the LiDAR usage data. The method further comprises providing, by the one or more processors, the map layer as an output.

According to another embodiment, an apparatus comprises at least one processor, and at least one memory including computer program code for one or more computer programs, the at least one memory and the computer program code configured to, with the at least one processor, cause, at least in part, the apparatus to determine Light Detection and Ranging (LiDAR) usage data generated by one or more mobile devices. The apparatus is also caused to generate a map layer of a geographic database based on the LiDAR usage data. The map layer indicates one or more locations where a LiDAR device was used by the one or more mobile devices based on the LiDAR usage data. The apparatus is further caused to provide the map layer as an output.

According to another embodiment, a computer program product may be provided. For example, a computer program product for determining one or more placement locations on a sidewalk area that are suitable for temporary placement of a shared micro-mobility vehicle, comprising instructions which, when the program is executed by a computer, cause the computer to determine Light Detection and Ranging (LiDAR) usage data generated by one or more mobile devices. The computer is also caused to generate a map layer of a geographic database based on the LiDAR usage data. The map layer indicates one or more locations where a LiDAR device was used by the one or more mobile devices based on the LiDAR usage data. The computers is further caused to provide the map layer as an output.

According to another embodiment, a non-transitory computer-readable storage medium carries one or more sequences of one or more instructions which, when executed by one or more processors, cause, at least in part, an apparatus to determine Light Detection and Ranging (LiDAR) usage data generated by one or more mobile devices. The apparatus is also caused to generate a map layer of a geographic database based on the LiDAR usage data. The map layer indicates one or more locations where a LiDAR device was used by the one or more mobile devices based on the LiDAR usage data. The apparatus is further caused to provide the map layer as an output.

According to another embodiment, an apparatus comprises means for determining Light Detection and Ranging (LiDAR) usage data generated by one or more mobile devices. The apparatus also comprises means for generating a map layer of a geographic database based on the LiDAR usage data. The map layer indicates one or more locations where a LiDAR device was used by the one or more mobile devices based on the LiDAR usage data. The apparatus further comprises means for providing the map layer as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of mapping and leveraging usage data of LiDAR on mobile devices, according to example embodiment(s);

FIG. 2 is diagram illustrating an example scenario for collecting LiDAR usage data, according to example embodiment(s);

FIG. 3 is a flowchart that summarizes a process for mapping and leveraging LiDAR usage data, according to example embodiment(s);

FIG. 4 is a diagram of a mapping platform capable of mapping and leveraging usage data of LiDAR on mobile devices, according to example embodiment(s);

FIG. 5 is diagram illustrating an example scenario for mapping and leveraging LiDAR usage data, according to example embodiment(s);

FIGS. 6A-6I are diagrams of example user interfaces for collecting and leveraging usage data of LiDAR on mobile devices, according to example embodiment(s);

FIG. 7 is a diagram of a geographic database, according to example embodiment(s);

FIG. 8 is a diagram of hardware that can be used to implement one or more example embodiments;

FIG. 9 is a diagram of a chip set that can be used to implement one or more example embodiments; and

FIG. 10 is a diagram of a mobile terminal (e.g., mobile device or component thereof) that can be used to implement one or more example embodiments.

### DESCRIPTION OF SOME EMBODIMENTS

Examples of a method, apparatus, and computer program for mapping and leveraging usage data of LiDAR on mobile devices are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

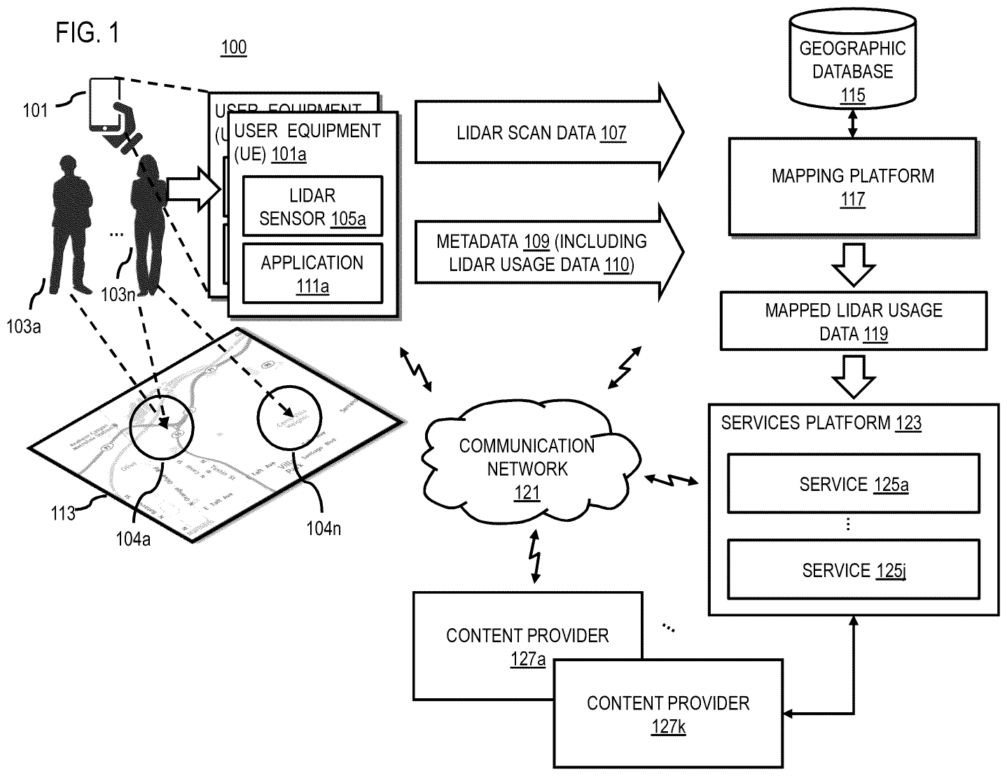

FIG. 1 is a diagram of a system 100 capable of mapping and leveraging usage data of LiDAR on mobile devices, according to example embodiment(s). As discussed above, one area of development for mapping and navigation services providers is in the area of localization of mobile devices 101a-101n (also referred to as user equipment 101, e.g., a mobile phone, augmented-reality device, wearable device, head-mounted device, tablet, portable computer, etc.). By way of example, one or more users 103a-103n (also referred to as users 103) at locations 104a-104n (herein after locations 104) can activate LiDAR sensors 105a-105n on the UEs 101 to perform LiDAR scans. In such cases, the user can capture and store LiDAR scan data 107 and/or metadata 109 (including but not limited to LiDAR usage data 110) for later access and/or sharing peer-to-peer.

In one embodiment, the UE 101 can execute an application 111 (e.g., a LiDAR navigation application) to capture the LiDAR scan data 107 and/or the metadata 109 as LiDAR-based location/path signature. However, there is no platform for mapping and providing access to the information in the LiDAR scan data 107 and/or the metadata 109.

To address these technical challenges, the system 100 of FIG. 1 introduces a capability to map and leverage usage data of LiDAR on mobile devices (e.g., into a map layer 113), to enable more efficient search of LiDAR usage data and/or to enable LiDAR-based localization/navigation, etc.

In one embodiment, the system 100 can generate map layer(s) representative of LiDAR usage based on crowdsourced data from mobile devices that use LiDAR for location-based use cases, such as localization, scanning characteristic recommendations for different environments or outcomes, geofence-driven transition among different localization technologies, etc. For instance, the system 100 can crowd-source from mobile devices LiDAR usage data (e.g., generated at mobile device(s)). As another instance, the system 100 can crowd-source LiDAR scan data from the mobile devices, and then generate LiDAR usage data. Additional data/metadata collected from a given mobile device can include one or more of: date(s) and/or time(s) of LiDAR usage/scanning, characteristics of LiDAR scan(s), length of scan(s), number of scans in a session, scanning orientation, stationary vs. moving scans, etc. The same or other map layer(s) can then include additional information for locations/areas of ‘LiDAR on phone’ usage based on the additional collected data. For example, the map layer may represent a given area of LiDAR usage and may indicate (e.g., average) scanning duration(s) for the given area, common manufacturers of devices using LiDAR in the given area, etc.

The system 100 can leverage the generated map layer(s), for example, to provide an interface to gather insights based on the map layer(s), automatically generating insights and recommendations based on the map layer(s), automatically or manually generate geofences/transitions for areas based on LiDAR usage data, etc. For example, the system 100 can automatically or the user can manually generate geofences/transitions based on area(s) of LiDAR usage. Such geofences can correspond to areas of extensive and successful LiDAR usage and can be adjusted dynamically based on available data. Such geofences can also improve suggested or automated transitions to LiDAR on phone for localization purposes.

In one embodiment, the system 100 can gather information on usage of other localization technologies in different areas, to improve geofence-driven transition between using the various technologies. For example, the system 100 can improve transition between using ‘LiDAR on phone’ for localization vs. using visual positioning services (e.g., camera-based navigation) for area(s) of interest or based on a targeted localization success rate, etc., thereby improving the overall indoor navigation experience for users, such as gradually blurring of camera-based navigation to illustrate a need to switch to LiDAR-based navigation.

In one embodiment, the system 100 can automatically generate insights and recommendations based on the map layer(s), e.g., to determine/suggest scan characteristics most suitable for different situations or desired outcomes, so as to help improve data collection experience or quality and/or improve localization, etc. For example, the system 100 can automatically determine that a certain phone model require a scanning duration of at least a particular length to ensure a localization or object detection success rate of at least 95%. Based on this, the system 100 can automatically provide guidance to a user of such phone model to scan for at least that time duration.

For example, the map layer may represent a given area of LiDAR usage and may indicate the following: average scanning duration(s) for the given area, common manufacturers of devices using LiDAR in the given area, LiDAR-based localization success rate for the given area, and/or types of objects detected in the given area, among numerous other combinations of data. The additional information can be the raw collected data (e.g., a list of scanning durations as collected from various devices in an area) and/or can be a modified representation of the raw collected data (e.g., automatically compute an average scanning duration for the given area over a pre-defined time period).

In one embodiment, the location data 104 can be determined from metadata 109 associated with the LiDAR scan data 107 that indicates where a LiDAR scan took place. In other embodiments, the metadata 109 can be associated with other sensors of the UEs 101, such as location sensors (e.g., a GPS receiver), acceleration sensors, gyroscopes, atmospheric pressure meters (e.g., a barometer), magnetic field meters (e.g., a magnetometer), cameras, microphones, etc., to determine the location data of LiDAR scan data 107.

In one embodiment, the system 100 can record in a database (e.g., the geographic database 115) users' LiDAR scan(s) (when allowed to do so, e.g., based on explicit consent and/or privacy settings at a location). The system 100 then can index and store the LiDAR scan(s) with respective metadata (e.g., location data tag(s), LiDAR scanning/usage data, etc.). The location tag(s) can be based on location(s) embedded in the LiDAR scans, location(s) embedded in metadata of the LiDAR scans, etc.

For instance, the location data 104 can be parsed from the metadata 109 or from the LiDAR scan data 107 (e.g., using computer vision and/or machine learning). In one embodiment, the metadata 109 can included location tags indicating precise or approximate locations that are determined using, for instance, any positioning system or service (e.g., WiFi, Bluetooth, Bluetooth low energy, 2/3/4/5/6G cellular signals, ultra-wideband (UWB) signals, etc.), when satellite positioning signals are unavailable.

Other examples of metadata are attributes including, but not limited to, identities/characteristics of UEs 101 and/or users 103 (e.g., based on user/device profile data), LiDAR usage data (including characteristics of the LiDAR scan(s)), activities engaged in during the LiDAR scan(s) (e.g., based on social media data), etc. With such data, the system 100 can enable LiDAR usage data to play a more prominent role in localization, scanning characteristic recommendations for different environments or outcomes, geofence-driven transition among different localization technologies, etc.

In one embodiment, the LiDAR scan data 107 and/or the metadata 109 (e.g., the LiDAR usage data 110) can be associated with any feasible representation of a location, such as a representation of geographic coordinate(s), address(es), digital map data record(s) (e.g., record(s) of a geographic database 115, a mapping platform 117, etc.) indicating map locations and/or features (e.g., points of interests, terrain features, geographic areas, structures, etc.) to generate mapped LiDAR usage data 119. In one embodiment, the mapped LiDAR usage data 119 can be a standalone data structure comprising the data records associating the LiDAR scan data 107 and/or the metadata 109 with respective locations represented in the geographic database 115 or can be an additional data layer (e.g., the map layer 113) of the geographic database 115 that is associated with other location data records of the geographic database 115. In one embodiment, the mapped LiDAR usage data 119 can be provided as an output from the system 100. For example, the output can be transmitted to UEs 101, services 125a-125j of a services platform 123—also collectively referred to as services 125, and/or content providers 127a-127k—also collectively referred to as content providers 127).

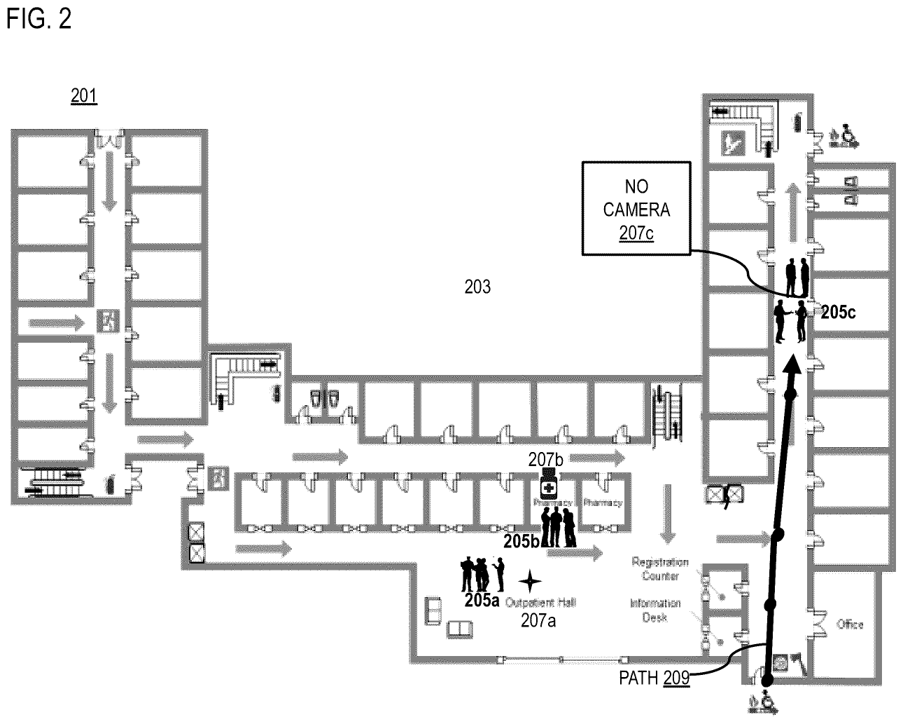

FIG. 2 is diagram illustrating an example scenario for mapping and leveraging LiDAR usage data, according to example embodiment(s). As shown, the system 100 can present a mapping user interface (UI) 201 that depicts a representation of a geographic area 203 (e.g., a hospital). On this geographic area 203, the system 100 depicts representations of LiDAR scan instances/clusters 205a-205c that have occurred within or that capture the respective geographic locations associated with each LiDAR scan instance/cluster 205a-205c. In this way, in response to a subsequently captured LiDAR scan by a user (e.g., a wheelchair side entrance), the system 100 can quickly compare previous LiDAR scans by location to locate the user and navigate accordingly (e.g., a path 209 to an MRI room for a scheduled appointment without going via the main entrance or checking with the information desk). As another example, in response to a user search query regarding one or more of the attributes/parameters of LiDAR usage (e.g., the most popular LiDAR scan site in the hospital), the system 100 can filter the mapped LiDAR usage data 119 based on the relevant attributes/parameters then present on the UI 201 accordingly (e.g., the center of the outpatient hall 207a marked with a star in FIG. 2 having the most number of LiDAR scans/cluster 205a).

In one embodiment, the system 100 can provide an interface to gather insights based on the map layer(s). The interface can support filtering of data in the map layer(s) in accordance with various factors. For example, a user can input via the interface requesting data filtered based on: (i) ‘LiDAR on phone’ usage areas where windows and/or mirrors (objects) were detected, (ii) only data for ‘moving’ scans in the area, and (iii) information on localization success rate. This can provide assess to LiDAR-based localization success rate data during ‘moving’ scanning in areas that have reflective/transparent objects, e.g., whether ‘moving’ during the scanning impacts the success rate under these specific circumstances.

For instance, an operator of the system 100 can assess whether ‘moving’ scanning degrades localization success rate in such areas, and configure user recommendations to engage in ‘stationary’ scanning when entering an area that has mirrors and/or windows. As another instance, a manager of an indoor space can better arrange placement of mirrors in the space, in order to improve the localization success rate when ‘moving’ scanning is utilized.

Optionally, the representations also contain graphics, thumbnails, and/or images of the locations/objects at the locations captured in the LiDAR scans. For instance, the representation of the LiDAR scans/cluster 205b includes a graphic 207b of a pharmacy. As another instance, the representation of the LiDAR scans/cluster 205c includes a thumbnail 207c of a warning sign that camera image capturing is prohibited to protect patient privacy (e.g., near an MRI room).

In one embodiment, the system 100 can apply computer vision algorithms on the LiDAR scan data 107 and/or the metadata 109 to identify the background (e.g., an outpatient hall, a pharmacy, a MRI room, etc.), the number of LiDAR scan users, the identities of the LiDAR scan users, etc. Knowing the identities of the LiDAR scan users, the system 100 can apply artificial intelligence on (1) the user profile data, social media data, etc., (2) user group profile data, etc. to predict the user's purpose of visit (e.g., annual physical check), and generate relevant navigation recommendations (e.g., “Please use any Self-Check-in kiosk in the Lobby”).

In other words, the system 100 can enable spatial queries to conveniently retrieve LiDAR usage data and/or LiDAR scans by leveraging the spatial information contained in the LiDAR scans (e.g., LiDAR scan data 107) and/or the metadata 109 associated with it. The system 100 can make such queries possible for LiDAR scan data 107 and/or the metadata 109 based both on the actual scanning locations, for localization, scanning characteristic recommendations for different environments or outcomes, geofence-driven transition among different localization technologies, etc.

Therefore, the system 100 can improve experience and/or guidance for users of LiDAR on phone, e.g., during data collection and/or localization, improve quality of collected LiDAR data and/or of LiDAR-based localization, and provide valuable insights to operators of a LiDAR-based localization system and/or to owners/managers of various indoor spaces (e.g., enterprises).

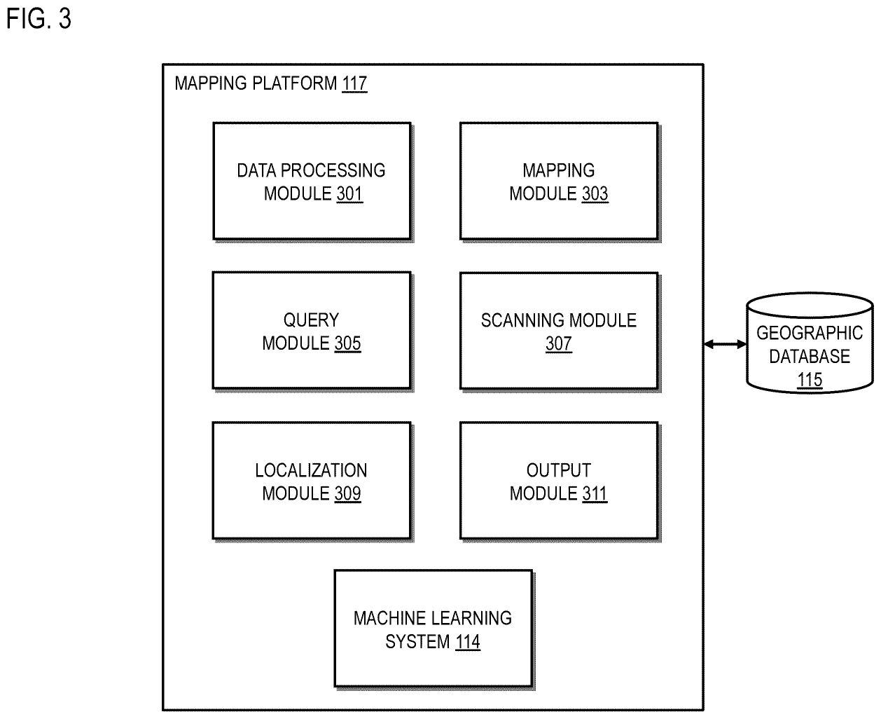

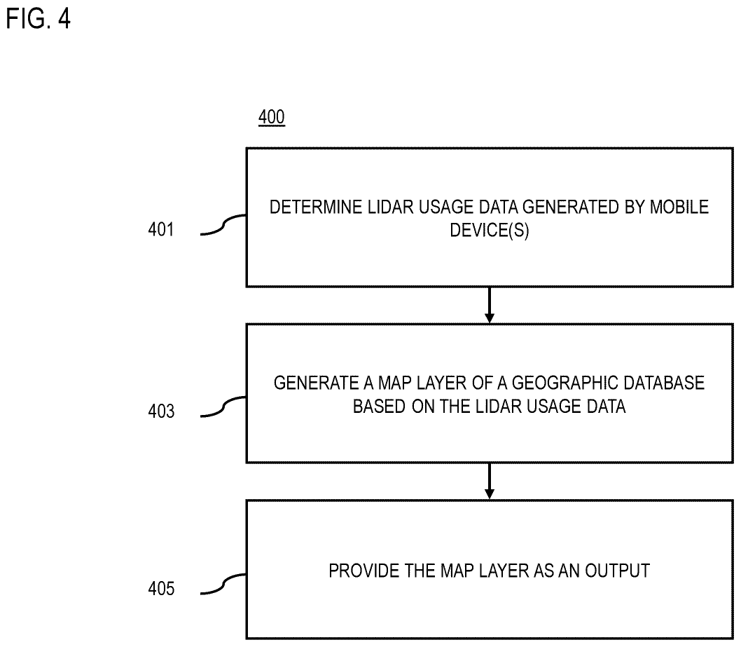

In one embodiment, as shown in FIG. 3, the mapping platform 117 of the system 100 includes one or more components for mapping LiDAR scan, according to the various embodiments described herein. It is contemplated that the functions of the components of the mapping platform 117 may be combined or performed by other components of equivalent functionality. As shown, in one embodiment, the mapping platform 117 includes a data processing module 301, a mapping module 303, a query module 305 (e.g., including a search algorithm for search among mapped LiDAR usage data 119 for information), a scanning module 307, a localization module 309, and an output module 311. The above presented modules and components of the mapping platform 117 can be implemented in hardware, firmware, software, or a combination thereof. Though depicted as a separate entity in FIG. 1, it is contemplated that the mapping platform 117 may be implemented as a module of any of the components of the system 100 (e.g., a component of the services platform 123, services 125, content providers 127, UE 101, etc.). In another embodiment, one or more of the modules 301-311 may be implemented as a cloud-based service, local service, native application, or combination thereof. The functions of the mapping platform and modules 301-311 are discussed with respect to FIGS. 4-6 below.

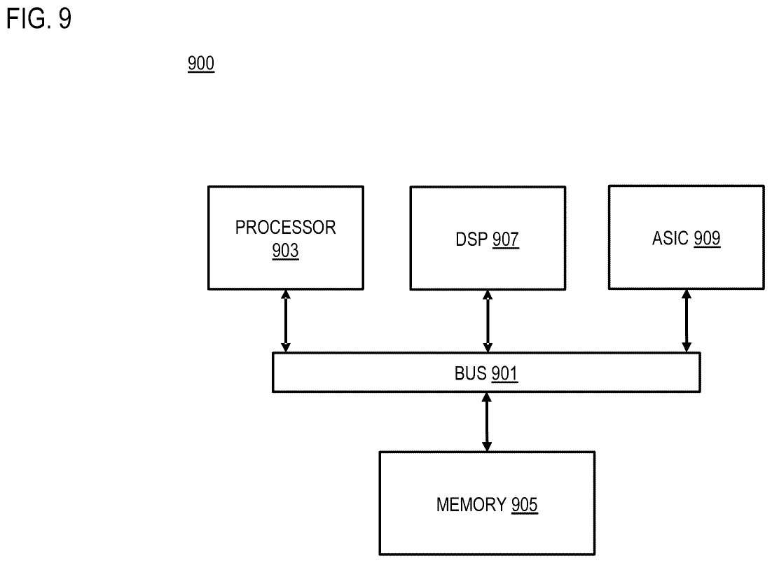

FIG. 4 is a diagram of a process 400 for mapping LiDAR scan, according to example embodiment(s). In various embodiments, the mapping platform 117 and/or any of the modules 301-311 may perform one or more portions of the process 400 and may be implemented in, for instance, a chip set including a processor and a memory as shown in FIG. 9. As such, the data mapping platform 117 and/or any of the modules 301-311 can provide means for accomplishing various parts of the process 400, as well as means for accomplishing embodiments of other processes described herein in conjunction with other components of the system 100. Although the process 400 is illustrated and described as a sequence of steps, it is contemplated that various embodiments of the process 400 may be performed in any order or combination and need not include all of the illustrated steps.

In one embodiment, for example, in step 401, the data processing module 301 can determine Light Detection and Ranging (LiDAR) usage data generated by one or more mobile devices (e.g., UEs 101). For instance, the LiDAR usage data can relate to usage of the LiDAR for localization, scanning characteristic recommendations for different environments or outcomes, geofence-driven transition among different localization technologies, or a combination thereof.

With the LiDAR scan location data, the mapping module 303 can associate or map the LiDAR scans and/or the LiDAR scan data 107 and/or the metadata 109 to a digital map for the query module 305 to conduct spatial analysis and filter the LiDAR usage data 110 related to various attributes/parameters.

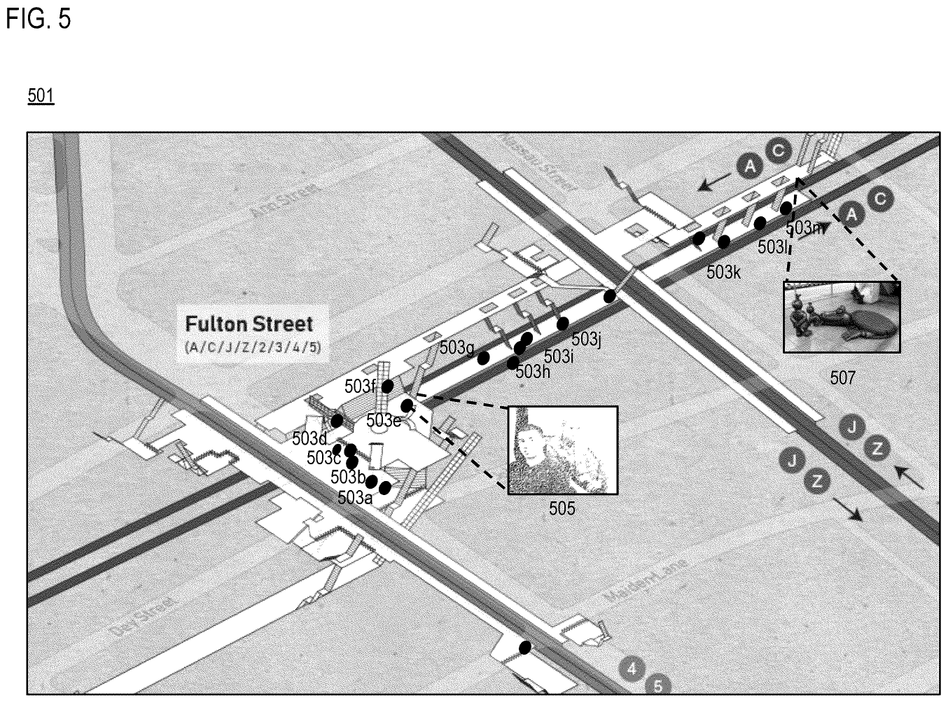

FIG. 5 is diagram illustrating an example scenario for mapping and leveraging LiDAR usage data, according to example embodiment(s). For instance, a mapping user interface (UI) 501 depicts a representation of the Fulton Street Subway Station in New York City where subway lines A/C/J/Z/2/3/4/5 meet. In FIG. 5, representations of LiDAR scan instances/clusters 503a-503m (e.g., in black dots) that have occurred within the subway stations, for example, near stairs, elevators, etc. where users are confused and then initiate LiDAR-based localization (e.g., since GPS signals are unavailable, and LiDAR are more efficient than camera-based localization).

In this way, in response to a subsequently captured LiDAR scan by a user (e.g., near an elevator connecting Line A and Line 4), the localization module 309 can quickly compare previous LiDAR scans by location within the subway station to determine the user's current location and navigate accordingly. In addition, the localization module 309 can aggregate each successful LiDAR-based localization instance into a LiDAR-based localization success rate per location. As another example, the localization module 309 can navigate a user via an underground route (e.g., a shortcut, or passing via POI like an underground mall) that requires LiDAR localization instead of staying on streets.

As another example, in response to a user search query regarding one or more of the attributes/parameters of LiDAR usage (e.g., the most popular LiDAR scan object in the subway station), the query module 305 can filter the mapped LiDAR usage data 119 based on the relevant attributes/parameters, and determine the most popular subway portrait artist. Since the most popular subway portrait artist requests no photo taken to stay anonymous, a lot of LiDAR scans were captured near the location the artist works. The output module 311 then can present on the UI 501 a thumbnail 505 of the most popular subway portrait artist, location/directions to get to his working location, some relevant LiDAR scans, etc. In another embodiment, the scanning module 307 can set up a geo-fence around the artist working location to prompt user(s) to or aquatically transition the UE 101 from a camera mode to LiDAR mode when capturing content depicting the artist.

LiDAR on UE 101 provides for several technical advantages including but not limited to:
Privacy sensitive/compliant location sharing as no personal information is captured (e.g., capturing 3D points of a point cloud representation or features extracted therefrom), in comparison, for instance, with a scene picture sharing (e.g., where visual characteristics are captured in more detail and can expose personally identifiable information);
More efficient in low-light conditions, compared to use of images (e.g., visual localization);
Acquisition speed/requirements (e.g., scan quality less susceptible to various movement(s) compared to use of images);
Depth sensing could help recognize a location from multiple angles because of 3D point capture, and is therefore, more robust that the two-dimensional capture of traditional images; and
Compared to LiDAR on cars, LiDAR on UE 101 (e.g., mobile or wearable devices) can be placed in numerous locations and orientations in the environment (e.g., indoor environments) that are not accessible from a car.

As another example, the query module 305 can determine based on user feedbacks of lacking a quality 3D scan of the most popular subway art 507 (e.g., a permanent public bronze sculpture of an alligator coming out of a manhole cover), since it is located at a location of busy people flows. As such, the scanning module 307 can prompt user(s) near the location of the most popular subway art 507 to take better LiDAR scan(s) during non-peak hours. For instance, more stationary scans, different scanning orientations, etc. to get better scanning results at the location, depending on device models, LiDAR type, capabilities, etc.

In addition, the scanning module 307 can use such better scanning results to improve future localization outcomes. For instance, the better identified 3D model of the most popular subway art 507 can help future user localization at or near the most popular subway art 507.

In one embodiment, in step 403, the mapping module 303 can generate a map layer of a geographic database based on the LiDAR usage data. The map layer can indicate one or more locations where a LiDAR device was used by the one or more mobile devices based on the LiDAR usage data. For instance, the map layer can be a heat map of a localization success rate (e.g., further filtered based on stationary scan, moving scan, scan orientation, LiDAR type, etc.). As other instances, the map layer can be a heat map of LiDAR scan number points, LiDAR scan quality points, etc. As other instances, the map layer can be a map of recommended LiDAR uses, location points of where GPS signal unavailable, area(s) camera prohibited such as no-camera zone, localization mode switching location points, POIs where people switching to LiDAR (e.g. switching to LiDAR in a large subway station, switching on a LiDAR application, etc.), etc.

In one embodiment, the mapping module 303 can customize the map layer(s) for an individual user or a specific user group (e.g., a user group commuting via a train station). In one embodiment, the mapping module 303 can customize LiDAR on/off condition(s), e.g., where only 1-2 satellite coverage, below a GPS signal strength threshold, etc. For instance, the LiDAR on/off condition(s) can be manually set by the user(s), then automatically set by the mapping module 303 after picking up the user LiDAR usage pattern(s). For example, the user can set a contextual switching on LiDAR, e.g., when the user is running late (e.g., for work) or time critical (e.g., going to an emergency room).

It is noted that although the various embodiments described herein are discussed with respect to using a LiDAR sensor 105 of a UE 101 to generate LiDAR scans, it is contemplated that any other type of depth sensing sensor (e.g., any other time-of-flight sensor capable of generating a point cloud representation of an environment) can be used equivalently in the embodiments described herein. By way of example, a LiDAR sensor 105 scans an environment by transmitting laser pulses to various points in the environment and records the time delay of the corresponding reflected laser pulse as received at the LiDAR sensor 105. The distance from the LiDAR sensor 105 to a particular point in the environment can be calculated based on the time delay. When the distance is combined with an elevation of the laser pulse as emitted from the LiDAR sensor 105, a three-dimensional (3D) coordinate point can be computed to represent the point on a surface in the environment to which the laser pulse was directed. By scanning multiple points in the environment, the LiDAR sensor 105 can generate a three-dimensional (3D) point cloud representation of the environment (e.g., LiDAR scan data 107). For instance, LiDAR data can be saved in standard file format types: .LAS (LiDAR Aerial Survey), .LAZ, etc. The LAS file is an open binary file that retains the information specific to LiDAR data, and it is also an interchangeable public file format for 3-dimensional point cloud conforming to the American Society of Photogrammetry and Remote Sensing (ASPRS) LiDAR data exchange format standard. A LAS file consists of the following four sections: (1) a public header block that describes format, number of points, extent of the point cloud, etc.; (2) variable length records (VLR, any optional records to provide various data such as the spatial reference system used, metadata, waveform packet information and user application data; (3) point data records of each individual point in the point cloud, including coordinates, classification (e.g. bare earth, high or low vegetation, building, etc.), flight and scan data, etc.; and (4) extended variable length records (EVLR, similar to VLRs yet allow a much larger data payload per record). LAZ is an extension used by a data format for compressed LiDAR data. In other words, the .LAZ file format is a compressed version of .LAS. As another instance, LiDAR data can be saved in proprietary file format type(s), for example, developed by a smart device platform.

In one embodiment, the LiDAR sensor 105 can be a hyperspectral sensor that scans the environment with laser pulses at different wavelengths to determine additional surface characteristics (e.g., surface material, etc.). For example differences in the time delay at different wavelengths can be indicative of differences in surface characteristics, and thus can be used to identify a surface characteristic. These additional characteristics can also be included in the metadata 109.

In one embodiment, the metadata 109 (including the LiDAR usage data 110, LiDAR-based location/path signature(s), etc.) can be computed from the LiDAR scan data 107. As mentioned, the LiDAR usage data has various attributes/parameters. As mentioned, location(s) where a LiDAR device was used can be based on location(s) embedded in the LiDAR scans, location(s) embedded in metadata of the LiDAR scans, etc.

As to other attributes/parameters, they can be crowdsourced from UEs 101 that use LiDAR for location-based use cases, such as localization, scanning characteristic recommendations for different environments or outcomes, geofence-driven transition among different localization technologies, etc. In one embodiment, the data processing module 301 can receive the LiDAR usage data directly from the one or more mobile devices (e.g., UEs 101 process raw sensor data (including LiDAR scan data 107, metadata 109 associated at least with the LiDAR sensor 105) into LiDAR usage data locally). In another embodiment, the data processing module 301 can receive LiDAR scan data 107 from the one or more mobile devices, and then process the received LiDAR scan data 107 to determine the LiDAR usage data.

For instance, the data processing module 301 can determine based on the metadata 109 (associated with sensors of the UEs 101, including the LiDAR sensor 105): a number/duration of LiDAR scans occurred at the location(s), a number of the mobile device(s) performing a LiDAR scan at the location(s), a date or time of LiDAR usage or scanning, a manufacturer, model, type, year, capabilities/features, a manufacturer of a LiDAR sensor used by the mobile device(s), a model of the LiDAR sensor, a type of the LiDAR sensor, one or more capabilities or features of the LiDAR sensor, a manufacturer of the mobile device(s), a model of the mobile device(s), a type of the mobile device(s), one or more capabilities or features of the mobile device(s), a number of scans in a scanning session, a scanning orientation, a moving versus stationary LiDAR scan, contextual information of a scanning environment, etc.

For instance, the data processing module 301 can determine a LiDAR-based localization success rate based on the metadata 109 and/or user feedbacks (e.g., survey). In one embodiment, the data processing module 301 can compare a LiDAR-based location with ground truth data, such as UE location(s) detected based on other sensor(s) of the UE 101, e.g., location sensors (e.g., a GPS receiver), acceleration sensors, gyroscopes, atmospheric pressure meters (e.g., a barometer), magnetic field meters (e.g., a magnetometer), cameras, microphones, etc. In another embodiment, the LiDAR-based localization success rate can be determined using one or more machine learning models using a machine learning system 114 as discussed later.

For instance, the data processing module 301 can determine based on the LiDAR scan data 107 and state-of-the-art 3D object detectors (e.g., VeloFCN, 3DOP, 3D YOLO, PointNet, PointNet++, etc.): a type of object at the location, a moving versus stationary LiDAR scan, contextual information of a scanning environment, etc.

Although various embodiments are described with respect to indoor LiDAR usage (including where satellite-based positioning technology (e.g., GNSS) are unavailable and/or potentially compromise privacy), it is contemplated that the approach described herein may be used with outdoor LiDAR usage.

A “LiDAR-based location signature” can be computed from a LiDAR scan (e.g., by extracting features from the 3D point cloud, subsampling the 3D point cloud, cropping the 3D point cloud, etc.). Such LiDAR location signatures can provide information about where the UE 101 is located, information about object(s) found at the location, and/or information about other characteristics/attributes associated with the location, among other possibilities. The UE 101 can use the LiDAR-based location signature to navigate to the location, identify or find the location, avoid the location, or identify changes to attributes/characteristics/objects in the location, depending on the context and/or uses case of the LiDAR-based location signature.

A “LiDAR path signature (also referred to as a depth-sensing path signature)” enables a UE 101 to collect a continuous LiDAR scan along a path or collect respective LiDAR scan(s) from time-to-time along the path. By way of example, corresponding LiDAR-based location signatures can be generated for each LiDAR scan of the points. Then the location signatures of the points can be combined or otherwise processed to generate the LiDAR path signature. In addition or alternatively, the LiDAR path signature can be generated directly from the LiDAR scans of the points without first computing individual LiDAR-based location signatures (e.g., by extracting features, subsampling, etc. the combined points clouds of the LiDAR scans of the path).

In one embodiment, the UE 101 (e.g., via the application 111) can share the metadata 109 with other UEs 101 (i.e., effect location sharing) via a geographic database (e.g., the geographic database 115) or otherwise store the metadata 109 locally for later reference or use. In either case, the UE 101 could use the metadata 109 to navigate to the location, identify or find the location, avoid the location, or identify changes to attributes/characteristics/objects in the location, depending on the context and/or use cases of the metadata 109.

In scenarios when GNSS signals are unavailable (e.g., subway stations, indoors, etc.), the system 100 can apply the metadata 109 and/or other positioning assisted navigation technologies, e.g., WiFi, Bluetooth, Bluetooth low energy, 2/3/4/5/6G cellular signals, ultra-wideband (UWB) signals, etc., and various combinations of the technologies and/or other sensor data, to derive the location data of the LiDAR scan data 107. By way of example, the system 100 can derive from either cellar network signals or WIFI access point data the location data of the LiDAR scans captured indoors and/or underground.

In one embodiment, the data processing module 301 can process the LiDAR usage data to determine one or more of: (i) a number of LiDAR scans that have occurred at the one or more locations, (ii) a duration of LiDAR scans that have occurred at the one or more locations, or (iii) a number of the one or more mobile devices that have performed a LiDAR scan at the one or more locations. The mapping module 303 can then include the one or more locations in the map layer based on determining one or more of: (i) that the number of LiDAR scans is greater than a threshold number of LiDAR scans, (ii) that the duration of LiDAR scans is greater than a threshold duration of LiDAR scans, or (iii) that the number of the one or more mobile devices is greater than a threshold number of mobile devices.

In another embodiment, the data processing module 301 can process the LiDAR usage data to determine parameters including a date or time of LiDAR usage or scanning, a manufacturer, model, type, year, capabilities/features, a manufacturer of a LiDAR sensor used by the one or more devices, a model of the LiDAR sensor, a type of the LiDAR sensor, one or more capabilities or features of the LiDAR sensor, a manufacturer of the one or more devices, a model of the one or more devices, a type of the one or more devices, one or more capabilities or features of the one or more devices, a LiDAR-based localization success rate, a type of object detected by a LiDAR scan, a number of scans in a scanning session, a scanning orientation, a moving versus stationary LiDAR scan, contextual information of a scanning environment, or a combination thereof. The map layer can further associate one or more of the parameters with the one or more locations.

In one embodiment, in step 405, the output module 311 can providing the map layer as an output. For instance, the query module 305 can process the output to generate a user interface depicting a representation of the map layer. By way of example, the user interface can present a user interface element to initiate a filtering of the map layer, and the filtering can be based on one or more of the parameters (e.g., the attributes/parameters of the LiDAR usage data 110, such as a number/duration of LiDAR scans occurred at the location(s), a number of the mobile device(s) performing a LiDAR scan at the location(s), etc.). As other examples, the output module 311 can automatically filter the mapped LiDAR usage data 119 to show reflective object(s) (e.g., mirrors reflecting LiDAR) that have been detected, moving scan(s), show area/location with 25% of localization success rate, etc. The more reflective objects in the region, the lower the localization success rate. In this case, the output module 311 can recommend a manager or owner of a space to better arrange items in the space, e.g., to reduce the number of reflective objects in the space. to improve localization success rate.

In another embodiment, the scanning module 307 can process the output to recommend a LiDAR scan parameter for a subsequent mobile device to perform a LiDAR scan.

In another embodiment, the localization module 309 can process the output to generate a geofenced area associated with LiDAR usage. For instance, the geofenced area can indicate an geographic area for transitioning to LiDAR for localization.

In one embodiment, the mapping module 303 can determine a geographic area, an indoor space, or a combination thereof where camera usage is prohibited based on the map layer. For instance, the mapping module 303 can determine information about an indoor space based on the map layer(s). In this case, areas of very extensive ‘LiDAR on phone’ usage can correlate to areas where camera usage is prohibited (e.g., hospitals), thereby enabling detection of areas in the indoor space where camera usage is prohibited.

In one embodiment, the system 100 and/or the user can initiate user interaction(s) with the LiDAR scan data 107 and/or the mapped LiDAR usage data 119, such as sharing them via the geographic database 115 (e.g., in the map layer 113), and/or directly with other user(s) (optionally complementing it with additional information, etc. via message(s), instant message(s), social media post(s), blog/vlog post(s), post(s) on user review site(s), etc.

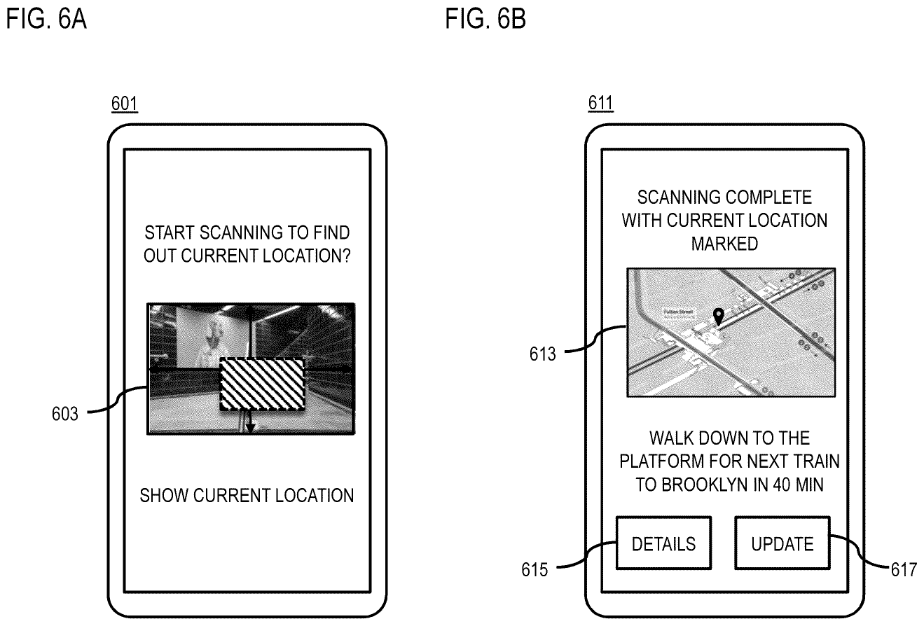

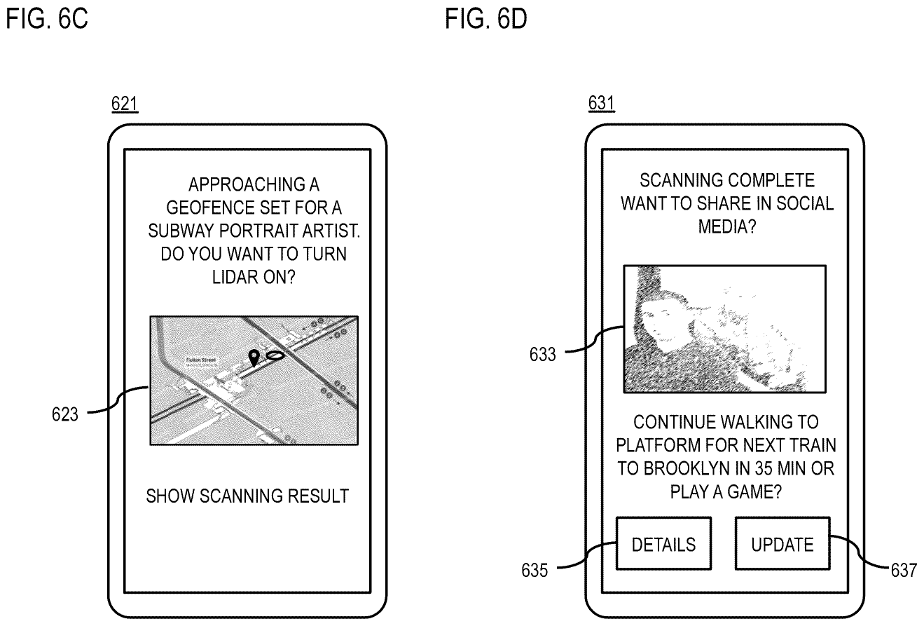

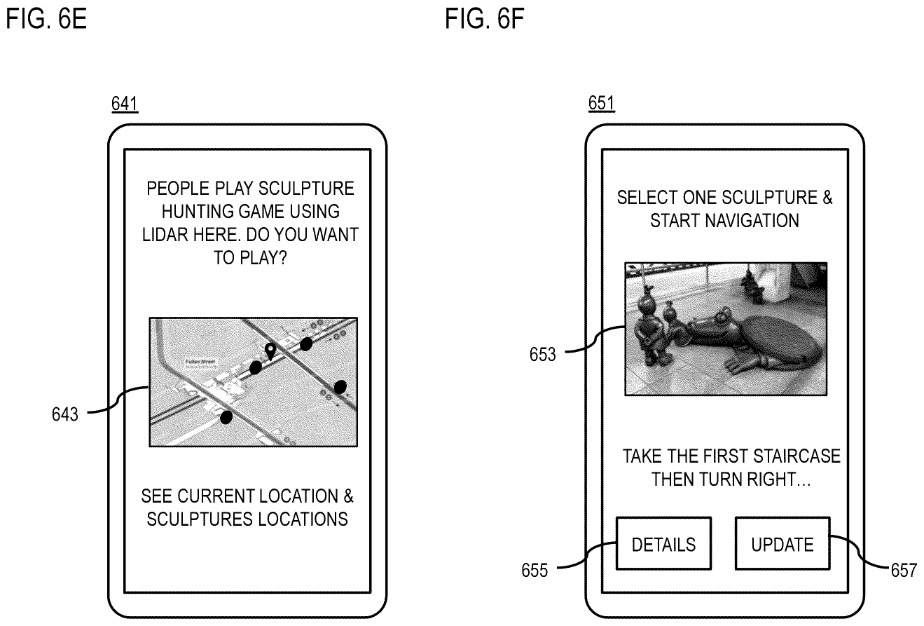

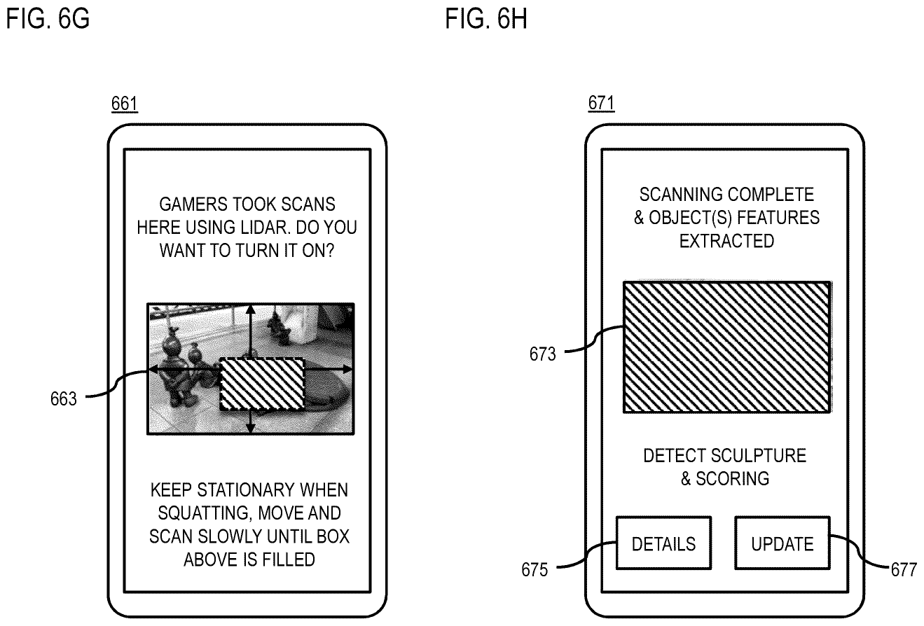

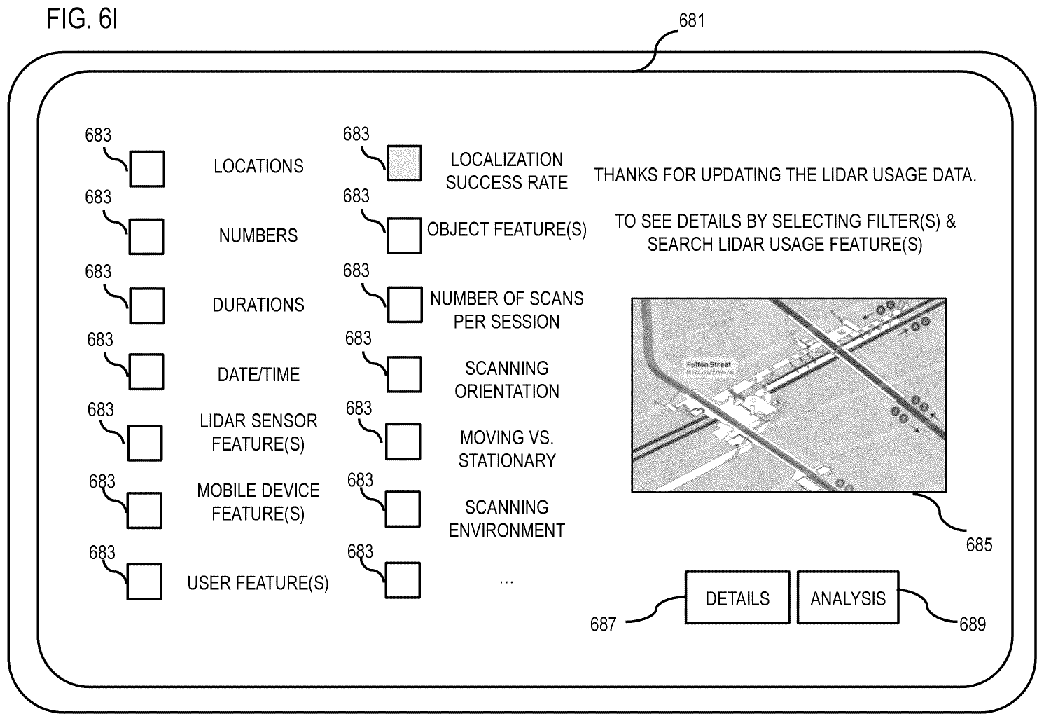

In one embodiment, the output module 311 can provide data for presenting a user interface indicating a representation of one or more of the LiDAR scanning/usage attributes/parameters, the LiDAR scan data 107, and/or the metadata 109. FIGS. 6A-6I are diagrams of example user interfaces for collecting and leveraging usage data of LiDAR on mobile devices, according to example embodiment(s). The attributes/parameters of the LiDAR usage data can be used to be leveraged in spatial and/or contextual queries. For instance, movement-related attributes/parameters, such as stationary vs. moving, etc. can be leveraged to give more context (e.g., scanning quality) to different use cases, such as localization (e.g., better scanning quality more accurate localization), scanning characteristic recommendations for different environments or outcomes, geofence-driven transition among different localization technologies (e.g., transition into LiDAR providing less scanning quality yet more privacy preservation), etc.

In one embodiment, example user interface (UI) 601 of FIG. 6A can present a user prompt of “start scanning to find out current location?” and a UI element 603 that indicates the orientation and directions to capture a LiDAR scan for localization. In this example, the scanning directions to cover are represented by respective arrows in the UI element 603 and a shaded area in the UI element 603 indicating the area of the environment that has already been scanned. The UI 601 instructs the user to start scanning and moving the UE 101 (e.g., a mobile phone) while scanning to completely fill shade UI element 603. When the user has scanned the specified area corresponding to the UE element 603, the UI 601 can display a messaging indicating “show current location” in FIG. 6B. Scanning, for instance, refers to moving the UE 101 in different point directions and/or orientations so that the emitted laser pulses of LiDAR sensor 105 covers the area of interest to generate a LiDAR scan of the user current location (e.g., a stair junction with a wall painting in a subway station).

In this case, example UI 611 of FIG. 6B can present a message of “scanning complete with current location marked” and a map 613 that marks the current location of the UE 101. The system 100 can determine a user destination based on a user input, calendar, mobility patterns, social media texts/posts, etc., to provide navigation recommendation(s). For instance, the UI 611 can present a recommendation of “walk down to the platform for next train to Brooklyn in 40 min,” and two options of “Details” 615 and “Update” 617. Upon a user selection of “Details” 615, the system 100 can provide details of the recommendation, such as the train line, stops, and final destination, etc. Upon a user selection of “Update” 617, the system 100 can provide the current stop of the train, updated estimate time of arrival (ETA), etc.

In another embodiment, a head-mounted device, such as the augmented-reality device can be used to replace the mobile phone. In this case, the system 100 can prompt the user to move the head to perform the scan, which is more intuitive and naturally align with the user's gaze.

When walking down to the platform, the system 100 can detect a geofence, and present example UI 621 of FIG. 6C with a user prompt of “Approaching a geofence for a subway portrait artist. Do you want to turn LiDAR on?” and a map 623 that marks a current location of the UE 101 and the geofence (in an oval shape). The UI 621 can display a messaging indicating “show scanning result” in FIG. 6D.

In this case, example UI 631 of FIG. 6D can present a message of “Scanning complete. Want to share in social media?” and a LiDAR scan 633 (e.g., of the subway portrait artist and his painting). Depending on the specification of the LiDAR sensor 105 and the distance to the surfaces being scanned, a typical LiDAR scan can have varying resolutions (e.g., point spacing of less approximately 0.5 meters) and accuracy (e.g., 1-20 mm accuracy). As mentioned, LiDAR resolution is generally much lower than traditional camera image resolution. The benefit of this decreased resolution (relative to traditional camera images) is that this preserves privacy (e.g., by obscuring any personally identifiable features) while still preserving geometric features that can uniquely represent a geographic environment (e.g., relative positions of surfaces and/or objects in the environment).

The UI 631 can further present a user prompt of “Continue walking to platform for next train to Brooklyn in 35 min or play a game?” and two options of “Details” 635 and “Update” 637. Upon a user selection of “Details” 635, the system 100 can provide details of the game, such as in FIG. 6E. Upon a user selection of “Update” 637, the system 100 can provide the current stop of the train, updated estimate time of arrival (ETA), etc.

In this case, example UI 641 of FIG. 6E can present a message of “people play sculpture hunting game using LiDAR here. Do you want to play?”, a map 643 that marks the current location of the UE 101 and locations of subway sculptures (in black dots), and another message of “see current location & sculptures locations.”

In one embodiment, example UI 651 of FIG. 6F can present a message of “Select one sculpture & start navigation” and an image 653 of the selected sculpture (e.g., the most popular subway art 507, i.e., a permanent public bronze sculpture of an alligator coming out of a manhole cover). The UI 651 also presents directions to sculpture: “Take the staircase then turn right . . . ,” and two options of “Details” 655 and “Update” 657. Upon a user selection of “Details” 655, the system 100 can provide details of the sculpture, such as the artist, year, materials, etc. Upon a user selection of “Update” 657, the system 100 can provide the current stop of the train, updated estimate time of arrival (ETA), etc.

When arriving at the sculpture, UI 661 of FIG. 6G can present a user prompt of “Gamers took scans here using LiDAR. Do you want to turn it on?” and a UI element 663 that indicates the orientation and directions to capture a LiDAR scan for the sculpture hunting game. In this example, since the system 100 determines to have the user take better quality scans, the UI 661 further presents instructions of “Keep stationary when squatting, move and scan slowly until box above if filled.”

In one embodiment, example UI 671 of FIG. 6H can present a message of “scanning complete & object(s) features extracted.” When the user has scanned the specified area corresponding to the UE element 663 (e.g., indicated by a completely shaded UI element 673 in UI 671 of FIG. 6H), a messaging indicating “scanning complete” can be displayed.

In this case, The system 100 can process the LiDAR scan to generate sculpture features that is representative of the location. The LiDAR scan, for instance, can be a point cloud of 3D coordinates representing the surfaces in the environment that has reflected the laser pulses of the LiDAR sensor. Accordingly, in one embodiment, the sculpture features can simply include a point cloud representing all or at least a portion of the environment of the location included in the LiDAR scan. To save storage space and reduce computer resources for processing larger sculpture feature(s) and/or point cloud(s), the system 100 can crop the LiDAR scan to depict a smaller area including the sculpture. In addition or alternatively, the processing of the LiDAR scan can comprise of extraction one or more features (e.g., surfaces, edges, corners, feature intersections, etc.) and including just the extracted features in the sculpture.

After processing the LiDAR scan and identifying the sculpture, the system 100 can display a messaging indicating “detect sculpture & scoring” in the UI 671, as well as two options of “Details” 675 and “Update” 677. Upon a user selection of “Details” 675, the system 100 can provide scoring information and other sculpture information. Upon a user selection of “Update” 677, the system 100 can provide the current stop of the train, updated estimate time of arrival (ETA), etc.

The sculpture features and corresponding location can be stored and/or updated locally at the UE 101, any other edge device, or the geographic database 115. In addition or alternately, the reference LiDAR point clouds can be created and/or stored by cloud components such as, but not limited to, the mapping platform 117, services platform 123, services 125, and/or content providers 127.

In one embodiment, the reference LiDAR point clouds can be generated procedurally from digital map data (e.g., the may layer 113, map data of the geographic database 115, etc.). For example, if the map includes, 3D modeling data of buildings or other features at a given location. The 3D modeling data can be converted to a 3D point cloud representation from which the corresponding POI/sculpture feature(s) can be created without scanning the sculpture again.

In one embodiment, the system 100 allows the user to access LiDAR usage data collected and leveraged based on the above-discussed embodiments. FIG. 6I illustrates an example UI 681 for accessing LiDAR usage attributes/parameters. In this case, the UI 681 shows a message of “Thanks for updating the LiDAR usage data. To see details by selecting filter(s) & search LiDAR usage features.” In this case, the UI 681 also lists LiDAR usage attributes/parameters 683 (e.g., locations, numbers, durations, date/time, LiDAR sensor feature(s), mobile device feature(s), user feature(s), localization success rate, object feature(s), number of scans per session, scanning orientation, moving vs. stationary, scanning environment, etc.) for user selections, in order to search for data of desirable attributes/parameters to display on a map 685 For instance, when the user selects “localization success rate”, the system 100 can display a heat map (not shown) of localization success rates in UI 681. In addition, the system 100 can prompt the user to prioritize the criteria. The system 100 can search based on the prioritized criteria, and display on the map 685 accordingly.

The UI 681 also shows two options of “Details” 687 and “Analysis” 689. Upon a user selection of “Details” 687, the system 100 can provide statistics of selected LiDAR usage attribute(s)/parameters. Upon a user selection of “Analysis” 689, the system 100 can perform analysis on the statistics of selected LiDAR usage attribute(s)/parameters. For example, the user can query: “Find me the most popular LiDAR scan site in a subway station between Time Square and Penn Station last week,” “Find me the location with the highest localization success rate in this subway station,” “Find me the shortest route to an underground mall,” etc.

In one embodiment, the machine learning system 114 can use one or more predictive algorithms (e.g., predictive machine learning models such as, but not limited to, a convolutional neural network) which uses LiDAR scanning characteristics (e.g., detected from LiDAR scan data 107 and/or the metadata 109) as input features to determine LiDAR scanning/usage characteristics (e.g., a LiDAR-based localization success rate). The system 100 can then determine scanning characteristic recommendations for different environments or outcomes, geofence-driven transition among different localization technologies, etc. By way of example, the LiDAR scanning/usage characteristics can be determined according to, but is not limited to, any of one or more of the following attributes:
Characteristics of LiDAR scan users (e.g., ages, man/woman, child/adult/senior citizen, physical disability, etc.);
Types of LiDAR sensors (e.g., based on models, capabilities, etc. embedded in UEs 101 of different models, capabilities, etc.);
Types of POIs, places, map features, etc. within a threshold proximity of LiDAR scan locations (e.g., based map data associated with the LiDAR scan locations);
Types of user activities (e.g., standing/stationary, walking, running, eating, listening to music on UEs 101, playing mobile games, shopping, pushing carts, driving, etc.) associated with LiDAR scans;
Information indicating whether LiDAR location signature(s) or LiDAR path signature(s) were collected, shared, or otherwise utilized.
Information about detected objects, object types, and/or whether object(s) are stationary (e.g., to know where the user is) or moving (e.g., to find a way for the user).
Information indicating whether or not whether object detection and/or localization was successful (based on user indication, localization error, ability/inability to match to a pre-defined object, etc.)
Time information (e.g., timestamps, LiDAR scan time frames, time of the day, work/school/event schedules, etc.).
Contextual information such as but not limited to event information, weather information, etc. associated with LiDAR scans

Using one or more of the above factors (or other features detectable from the LiDAR scan data 107, metadata 109, other sensor data, etc.), the system 100 can identify LiDAR characteristics, the LiDAR usage data 110, background, etc., to support subsequent spatial queries about a particular LiDAR scan, a series of LiDAR scans, a subset of the LiDAR usage data 110, etc.

In one embodiment, a machine learning model is trained to determine LiDAR scanning/usage characteristics (including a LiDAR-based localization success rate) for different user groups based on different time thresholds (e.g., a time-out) since the system 100 or the user initiates LiDAR-based localization. The LiDAR-based localization is determined as successful is completed before time-out. For instance, for a user group of aged 20-35, the LiDAR-based localization time-out at 30-60 seconds, since they are more technically savvy. As another instance, the LiDAR-based localization time-out is set as 1-3 minutes for a group of senior citizens. By analogy, different time-out periods can be set for different POIs, since some POIs may be more unique/special than the other ones to be identified.

In another embodiment, the more powerful (hardware and/or software) of the LiDAR sensors and/or their UEs 101, the shorter the time-out periods. In yet another embodiment, the more districting the user activity, the event, or the weather, the longer the time-out periods.

During training, a model training component feeds extracted features from the LiDAR scan data 107 and/or the metadata 109 into a machine learning model (e.g., neural network) to compute LiDAR scanning/usage characteristics (e.g., the LiDAR usage data attributes/parameters) using an initial set of model attributes/parameters. The model training component then compares the LiDAR scanning/usage characteristics to the training data. The model training component computes a loss function representing an accuracy of the LiDAR scanning/usage characteristics for the initial set of model parameters. The model training component then incrementally adjusts the model parameters until the model minimizes the loss function (e.g., achieves a target identification accuracy). In other words, a “trained” machine learning model for determining LiDAR scanning/usage characteristics is a machine learning model with parameters (e.g., coefficients, weights, etc.) adjusted to determine accurate LiDAR scanning/usage characteristics with respect to the training data.

It is noted that the features listed above are provided by way of illustration and not as limitations. It is contemplated that any features that are LiDAR-based and location-tagged may be applicable to the various embodiments described herein.

By determining the LiDAR scanning/usage characteristics, the system 100 can also classify a corresponding geographic location, area, route, POI, map feature, etc. based on the LiDAR scanning/usage characteristics obtained from the LiDAR scan data 107 and/or the metadata 109. In addition, the system 100 can determine background, the user characteristics, the user identities, etc. based on the LiDAR scanning/usage characteristics and/or features, thereby providing scanning characteristic recommendations for different environments or outcomes, geofence-driven transition among different localization technologies, etc.

After the LiDAR scans, the metadata, the LiDAR usage statistics and/or the map layers are create, updated, and/or verified according to the embodiments described herein, they can be provided to the users, the data makers, and/or any other users based on relevant privacy settings. In one embodiment, the system 100 can support non-LiDAR scan users to access the LiDAR scans and/or LiDAR usage statistics based on privacy settings of LiDAR scan users regarding access rights by different entities. Each LiDAR scan user can set up the user's own privacy settings (e.g., access rights) to enable or restrict scanning and/or output LiDAR scans per location, per user or user group (e.g., family, friends, colleagues, etc.), per company (e.g., banks, e-commerce stores, etc.), per service platform (e.g., internet services, social network services, gaming services, etc.), per advertiser, per location (e.g., restricted facilities), etc. For instance, the system 100 can implement privacy settings set by location owners/operators (e.g., companies, data centers, research laboratories, government agencies, etc.). By way of example, such privacy settings can allow free-access (i.e., no access restrictions) to high level topics of LiDAR scans and/or LiDAR usage statistics could be access-free, while requiring re-authentication and/or higher levels of authentication to access specific details of the LiDAR scans and/or LiDAR usage statistics (e.g., the details of a confidential project), and/or LiDAR scans occurred in restricted access facilities (e.g., hospitals, military bases, etc.).

Although various embodiments are described with respect to LiDAR scans and/or LiDAR usage statistics recorded in a physical world, it is contemplated that the approach described may be used within a virtual world. As virtual reality (VR) becomes more popular, LiDAR scans and/or LiDAR usage statistics can be recorded in a virtual world and processed by the system 100 the same manners as they occur in a physical world. As such, users can query LiDAR scans and/or LiDAR usage statistics recorded in a virtual world based on an associated location, such as a physical location simulated in the a virtual world, a virtual location existing in the virtual world, a physical or virtual location mentioned in the LiDAR scans and/or LiDAR usage statistics, etc. A virtual location may have a link to the real world. For example, the system 100 can support virtual reality travel applications (that provide “realistic” virtual experiences) to assign user LiDAR scans and/or LiDAR usage statistics to the locations presented via virtual reality, even when the LiDAR scans occur at a different real world location (e.g., home). A virtual location may have no link to the real world. For instance, users playing a virtual reality game (e.g., a Rome war game) can converse with each other and tag the LiDAR scan(s) and/or LiDAR usage statistics with a virtual location in the game.

For example, the LiDAR scans, the metadata, the LiDAR usage statistics and/or the map layers can be provided back to the UEs 101, and/or other equivalent users as map data or as processed service information (e.g., provided by the services platform 123, the services 125, and/or the content providers 127). More specifically, the system 100 can provide the LiDAR scans, the metadata, the LiDAR usage statistics and/or the map layers to user via an alert of an LiDAR scan location tag. In response, the receiving users (e.g., UEs 101) can request to display the LiDAR scans, the metadata, the LiDAR usage statistics and/or the map layers.

The above-discussed embodiments can support users to conveniently retrieve a location-associated LiDAR scan by leveraging the spatial information contained in that LiDAR scan and/or LiDAR scanning/usage data and/or the metadata associated with it.

The above-discussed embodiments can compute map layer(s) of LiDAR scanning/usage data in a given area, then present the map layer(s) on a map for the users in response to spatial queries.

The above-discussed embodiments can find a LiDAR scan based on a combined context of a location, LiDAR scan user(s), LiDAR scanning/usage characteristic(s), etc. The location based can be a location of a LiDAR scan and/or a tagged location(s) in the metadata of the LiDAR scan.

Returning to FIG. 1, in one embodiment, the mapping platform 117 of system 100 has access to the geographic database 115 for storing LiDAR scan data 107 and/or the metadata 109 and/or the resulting surface footprints and map data layers generated based on the LiDAR scanning/usage characteristics detected in the LiDAR scan data 107 and/or the metadata 109. In one embodiment, the mapping platform 117 also has connectivity to the geographic database 115 to provide location-based services based on the LiDAR scan data 107 and/or the metadata 109 and/or surface footprints and map data layers. The mapping platform 117 can operate, for instance, in connection with UEs 101 and/or modes of transport (e.g., vehicles, planes, aerial drone vehicles, motorcycles, boats, bicycles, etc.) to provide LiDAR scan(s) as requested. The UE 101 may be a personal navigation device (“PND”), a cellular telephone, a mobile phone, a personal digital assistant (“PDA”), a watch, a camera, a computer, and/or any other device that supports location-based services, e.g., digital routing and map display. It is contemplated that a device employed by a LiDAR scan users 103 may be interfaced with an on-board navigation system of a mode of transport (e.g., a vehicle) or wirelessly/physically connected to the vehicle to serve as the navigation system. Also, the UE 101 may be configured to access a communication network 121 by way of any known or still developing communication protocols to transmit and/or receive LiDAR scan data 107 and/or the metadata 109, surface footprints, and/or map data layers.

Also, the UE 101 and/or mode of transport (e.g., a vehicle) may be configured with an application 111 for collecting LiDAR scan data 107 and/or the metadata 109 and/or for interacting with one or more content providers 127, services 125 of the services platform 123, or a combination thereof. The application 111 may be any type of application that is executable on UE 101 and/or the mode of transport, such as mapping applications, location-based service applications, navigation applications, content provisioning services, camera/imaging applications, media player applications, social networking applications, calendar applications, and the like. In one embodiment, the application 111 may act as a client for the mapping platform 117 and perform one or more functions of the mapping platform 117 alone or in combination with the mapping platform 117. In yet another embodiment, the content providers 127, services 125, and/or services platform 123 receive the surface footprints and map data layers generated by the mapping platform 117 for executing its functions and/or services.

UE 101 and/or the mode of transport may be configured with various sensors (not shown for illustrative convenience) for acquiring and/or generating LiDAR scan data 107 and/or the metadata 109 (e.g., street level imagery), probe or trajectory data associated with a vehicle, a driver, other vehicles, conditions regarding the driving environment or roadway, etc. For example, sensors may be used as GNSS/GPS receivers for interacting with one or more navigation satellites to determine and track the current speed, position and location of a vehicle travelling along a roadway. In addition, the sensors may gather other vehicle sensor data such as but not limited to tilt data (e.g., a degree of incline or decline of the vehicle during travel), motion data, light data, sound data, image data, weather data, temporal data and other data associated with the vehicle and/or UEs 101. Still further, the sensors may detect local or transient network and/or wireless signals, such as those transmitted by nearby devices during navigation of a vehicle along a roadway (Li-Fi, near field communication (NFC)) etc. This may include, for example, network routers configured within a premise (e.g., home or business), another UE 101 or vehicle or a communications-capable traffic system (e.g., traffic lights, traffic cameras, traffic signals, digital signage, etc.).

It is noted therefore that the above described data may be transmitted via the communication network 121 as LiDAR scan data 107 and/or the metadata 109, surface footprints, and/or map data layers, according to any known wireless communication protocols. For example, each UE 101, mobile application 111, user, and/or the vehicle may be assigned a unique probe identifier (probe ID) or pseudonym for use in reporting or transmitting data collected by the modes of transport and UEs 101. In one embodiment, each UE 101 and/or vehicle is configured to report probe data as probe points, which are individual data records collected at a point in time that records location data. Probes or probe points can be collected by the system 100 from the UEs 101, applications 111, and/or modes of transport (e.g., vehicles) in real-time, in batches, continuously, or at any other frequency requested by the system 100 over, for instance, the communication network 121 for processing by the mapping platform 117.

In one embodiment, the mapping platform 117 retrieves aggregated probe points gathered and/or generated by UE 101 resulting from the travel of UEs 101, and modes of transport on a road segment or other travel network (e.g., pedestrian paths, etc.). A probe database (not shown) can be used to store a plurality of probe points and/or trajectories (e.g., trajectory data) generated by different UEs 101, applications 111, modes of transport, etc. over a period of time. A time sequence of probe points specifies a trajectory—i.e., a path traversed by a UE 101, application 111, modes of transport, etc. over a period of time. In one embodiment, the trajectory data can be used for location alignment of the LiDAR scan data 107 and/or the metadata 109 captured by the corresponding UE 101 and/or vehicle.

In one embodiment, the communication network 121 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the mapping platform 117 may be a platform with multiple interconnected components. The mapping platform 117 may include multiple servers, intelligent networking devices, computing devices, components, and corresponding software for minding pedestrian and/or vehicle specific probe data from mix-mode probe data. In addition, it is noted that the mapping platform 117 may be a separate entity of the system 100, a part of the one or more services 125 of the services platform 123, or included within the UE 101 (e.g., as part of the applications 111).

In one embodiment, the content providers 127 may provide content or data (e.g., probe data) to the components of the system 100. The content provided may be any type of content, such as LiDAR scan data 107 and/or the metadata 109 and/or surface footprints and map data layers, location data, textual content, audio content, video content, image content, etc. In one embodiment, the content providers 127 may also store content associated with the modes of transport, the UE 101, the mapping platform 117, and/or the services 125. In another embodiment, the content providers 127 may manage access to a central repository of data, and offer a consistent, standard interface to data, such as a trajectories database, a repository of probe data, average travel times for one or more road links or travel routes (e.g., during free flow periods, day time periods, rush hour periods, nighttime periods, or a combination thereof), speed information for at least one vehicle, other traffic information, etc. Any known or still developing methods, techniques, or processes for retrieving and/or accessing trajectory or probe data from one or more sources may be employed by the mapping platform 117.

By way of example, the UE 101, application 111, modes of transport, and mapping platform 117 communicate with each other and other components of the system 100 using well known, new or still developing protocols. In this context, a protocol includes a set of rules defining how the network nodes within the communication network 121 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is the to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

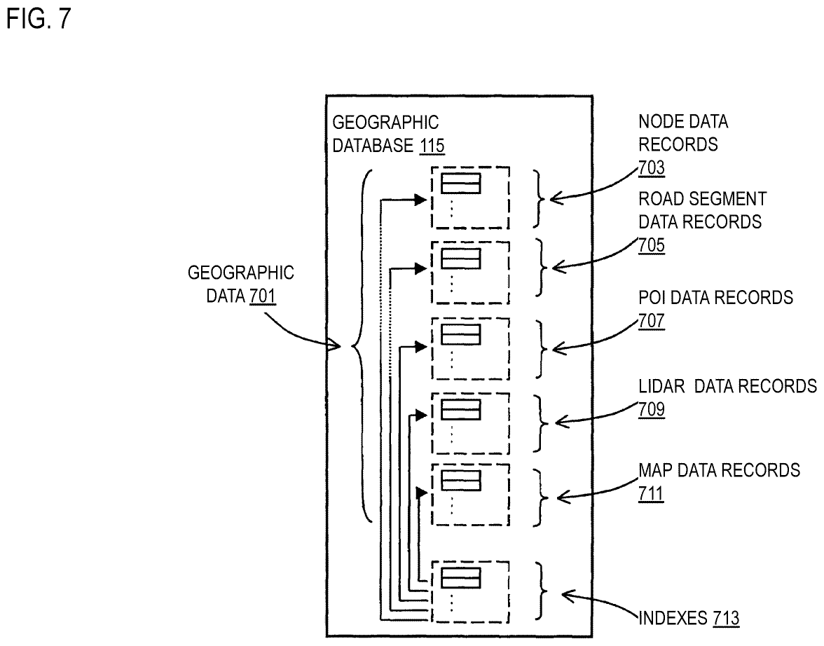

FIG. 7 is a diagram of a geographic database (such as the database 115), according to one embodiment. In one embodiment, the geographic database 115 includes geographic data 701 used for (or configured to be compiled to be used for) mapping and/or navigation-related services, such as for video odometry based on the parametric representation of lanes include, e.g., encoding and/or decoding parametric representations into lane lines. In one embodiment, the geographic database 115 include high resolution or high definition (HD) mapping data that provide centimeter-level or better accuracy of map features. For example, the geographic database 115 can be based on Light Detection and Ranging (LiDAR) or equivalent technology to collect very large numbers of 3D points depending on the context (e.g., a single street/scene, a country, etc.) and model road surfaces and other map features down to the number lanes and their widths. In one embodiment, the mapping data (e.g., mapping data records 711) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 115.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 115 follows certain conventions. For example, links do not cross themselves and do not cross each other except at a node. Also, there are no duplicated shape points, nodes, or links. Two links that connect each other have a common node. In the geographic database 115, overlapping geographic features are represented by overlapping polygons. When polygons overlap, the boundary of one polygon crosses the boundary of the other polygon. In the geographic database 115, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 115 includes node data records 703, road segment or link data records 705, POI data records 707, LiDAR data records 709, mapping data records 711, and indexes 713, for example. More, fewer or different data records can be provided. In one embodiment, additional data records (not shown) can include cartographic (“cartel”) data records, routing data, and maneuver data. In one embodiment, the indexes 713 may improve the speed of data retrieval operations in the geographic database 115. In one embodiment, the indexes 713 may be used to quickly locate data without having to search every row in the geographic database 115 every time it is accessed. For example, in one embodiment, the indexes 713 can be a spatial index of the polygon points associated with stored feature polygons.

In exemplary embodiments, the road segment data records 705 are links or segments representing roads, streets, or paths, as can be used in the calculated route or recorded route information for determination of one or more personalized routes. The node data records 703 are end points (such as intersections) corresponding to the respective links or segments of the road segment data records 705. The road link data records 705 and the node data records 703 represent a road network, such as used by vehicles, cars, and/or other entities. Alternatively, the geographic database 115 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 115 can include data about the POIs and their respective locations in the POI data records 707. The geographic database 115 can also include data about places, such as cities, towns, or other communities, and other geographic features, such as bodies of water, mountain ranges, etc. Such place or feature data can be part of the POI data records 707 or can be associated with POIs or POI data records 707 (such as a data point used for displaying or representing a position of a city). In one embodiment, certain attributes, such as lane marking data records, mapping data records and/or other attributes can be features or layers associated with the link-node structure of the database.

In one embodiment, the geographic database 115 can also include LiDAR data records 709 for storing the LiDAR scans, the metadata, the LiDAR usage statistics, the map layers training data, prediction models, annotated observations, computed featured distributions, sampling probabilities, and/or any other data generated or used by the system 100 according to the various embodiments described herein. By way of example, the LiDAR data records 709 can be associated with one or more of the node records 703, road segment records 705, and/or POI data records 707 to support localization or visual odometry based on the features stored therein and the corresponding estimated quality of the features. In this way, the LiDAR data records 709 can also be associated with or used to classify the characteristics or metadata of the corresponding records 703, 705, and/or 707.

In one embodiment, as discussed above, the mapping data records 711 model road surfaces and other map features to centimeter-level or better accuracy. The mapping data records 711 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 711 are divided into spatial partitions of varying sizes to provide mapping data to vehicles and other end user devices with near real-time speed without overloading the available resources of the vehicles and/or devices (e.g., computational, memory, bandwidth, etc. resources).

In one embodiment, the mapping data records 711 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the mapping data records 711.

In one embodiment, the mapping data records 711 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 115 can be maintained by the content provider 127 in association with the services platform 123 (e.g., a map developer). The map developer can collect geographic data to generate and enhance the geographic database 115. There can be different ways used by the map developer to collect data. These ways can include obtaining data from other sources, such as municipalities or respective geographic authorities. In addition, the map developer can employ field personnel to travel by vehicle (e.g., vehicles and/or UEs 101) along roads throughout the geographic region to observe features and/or record information about them, for example. Also, remote sensing, such as aerial or satellite photography, can be used.

The geographic database 115 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle or a UE 101, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for mapping and leveraging usage data of LiDAR on mobile devices may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

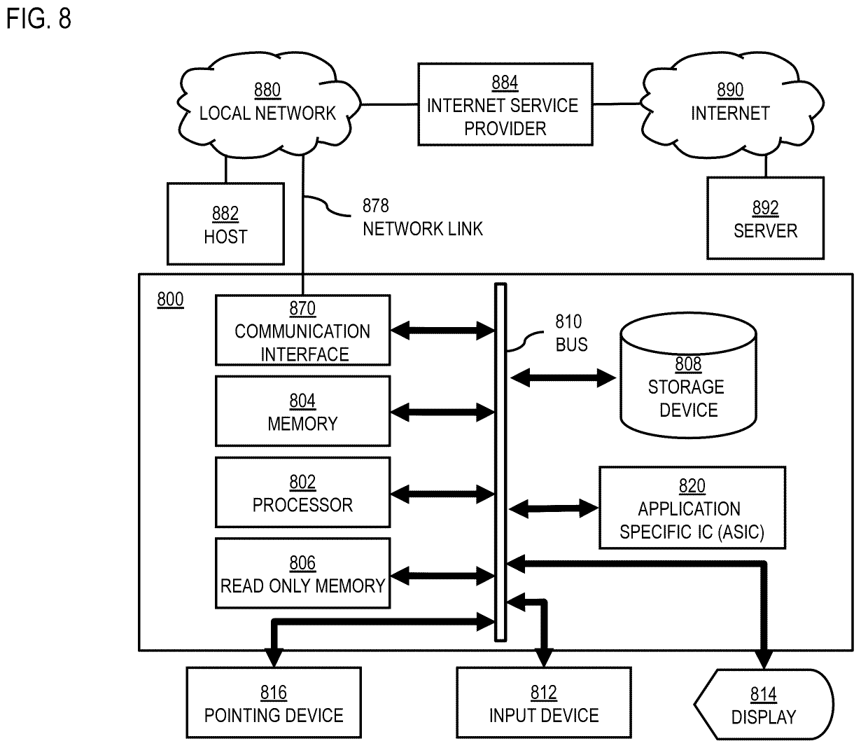

FIG. 8 illustrates a computer system 800 upon which an embodiment of the invention may be implemented. Computer system 800 is programmed (e.g., via computer program code or instructions) to map and leverage usage data of LiDAR on mobile devices as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to mapping and leveraging usage data of LiDAR on mobile devices. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RANI) or other dynamic storage device, stores information including processor instructions for mapping and leveraging usage data of LiDAR on mobile devices. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for mapping and leveraging usage data of LiDAR on mobile devices, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 121 for mapping and leveraging usage data of LiDAR on mobile devices.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system can be deployed in various configurations within other computer systems, e.g., host 882 and server 892.

FIG. 9 illustrates a chip set 900 upon which an embodiment of the invention may be implemented. Chip set 900 is programmed to map and leverage usage data of LiDAR on mobile devices as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to map and leverage usage data of LiDAR on mobile devices. The memory 905 also stores the data associated with or generated by the execution of the inventive steps.

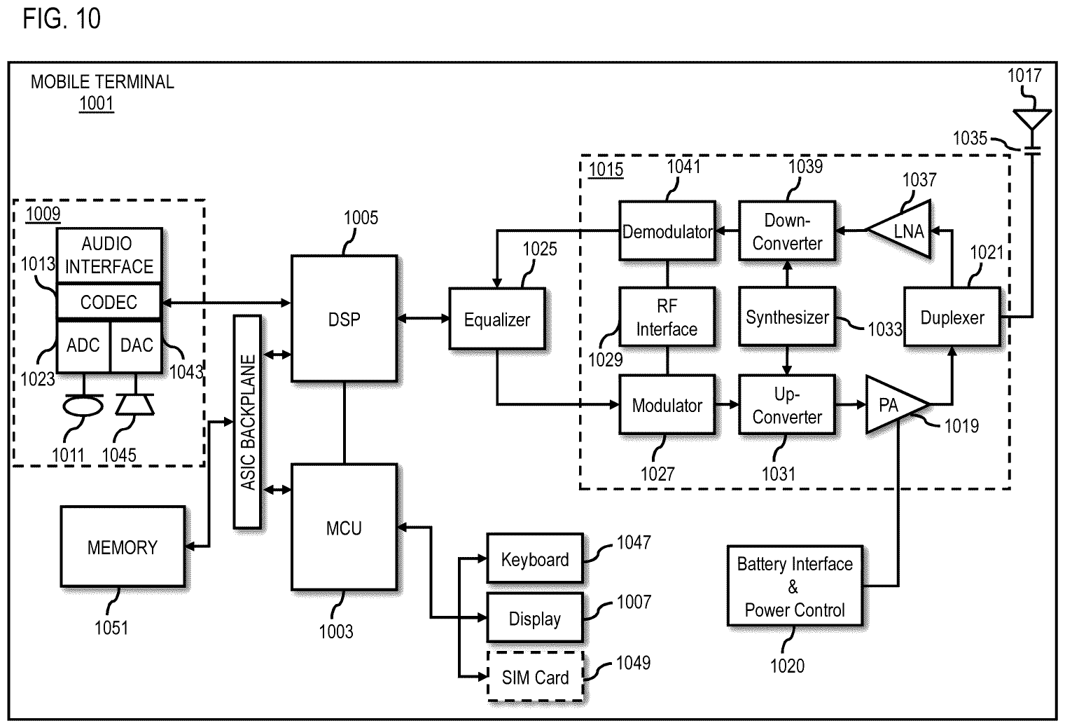

FIG. 10 is a diagram of exemplary components of a mobile terminal 1001 (e.g., handset or vehicle or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to map and leverage usage data of LiDAR on mobile devices. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining, by one or more processors, Light Detection and Ranging (LiDAR) usage data generated by one or more mobile devices;
generating, by the one or more processors, a map layer of a geographic database based on the LiDAR usage data, wherein the map layer indicates one or more locations where a LiDAR device was used by the one or more mobile devices based on the LiDAR usage data; and
providing, by the one or more processors, the map layer as an output.

2. The method of claim 1, further comprising:
processing the LiDAR usage data to determine one or more of: (i) a number of LiDAR scans that have occurred at the one or more locations, (ii) a duration of LiDAR scans that have occurred at the one or more locations, or (iii) a number of the one or more mobile devices that have performed a LiDAR scan at the one or more locations; and
including the one or more locations in the map layer based on determining one or more of: (i) that the number of LiDAR scans is greater than a threshold number of LiDAR scans, (ii) that the duration of LiDAR scans is greater than a threshold duration of LiDAR scans, or (iii) that the number of the one or more mobile devices is greater than a threshold number of mobile devices.

3. The method of claim 1, wherein the usage data relates to usage of the LiDAR for localization.

4. The method of claim 1, further comprising:
processing the LiDAR usage data to determine parameters including a date or time of LiDAR usage or scanning, a manufacturer, model, type, year, capabilities/features, a manufacturer of a LiDAR sensor used by the one or more devices, a model of the LiDAR sensor, a type of the LiDAR sensor, one or more capabilities or features of the LiDAR sensor, a manufacturer of the one or more devices, a model of the one or more devices, a type of the one or more devices, one or more capabilities or features of the one or more devices, a LiDAR-based localization success rate, a type of object detected by a LiDAR scan, a number of scans in a scanning session, a scanning orientation, a moving versus stationary LiDAR scan, contextual information of a scanning environment, or a combination thereof,
wherein the map layer further associates one or more of the parameters with the one or more locations.

5. The method of claim 1, further comprising:
processing the output to generate a user interface depicting a representation of the map layer.

6. The method of claim 5, wherein the user interface presents a user interface element to initiate a filtering of the map layer, and wherein the filtering is based on one or more of the parameters.

7. The method of claim 1, further comprising:
processing the output to recommend a LiDAR scan parameter for a subsequent mobile device to perform a LiDAR scan.

8. The method of claim 1, further comprising:
determining a geographic area, an indoor space, or a combination thereof where camera usage is prohibited based on the map layer.

9. The method of claim 1, further comprising:
processing the output to generate a geofenced area associated with LiDAR usage.

10. The method of claim 9, wherein the geofenced area indicates an geographic area for transitioning to LiDAR for localization.

11. The method of claim 1, further comprising:
receiving the LiDAR usage data from the one or more mobile devices.

12. The method of claim 1, further comprising:
receiving LiDAR sensor data from the one or more mobile devices; and
processing the received LiDAR sensor data to determine the LiDAR usage data.

13. An apparatus comprising:
at least one processor; and
at least one memory including computer program code for one or more programs,
the at least one memory and the computer program code configured to, with the at least one processor, cause the apparatus to perform at least the following,
determine Light Detection and Ranging (LiDAR) usage data generated by one or more mobile devices;
generate a map layer of a geographic database based on the LiDAR usage data, wherein the map layer indicates one or more locations where a LiDAR device was used by the one or more mobile devices based on the LiDAR usage data; and
provide the map layer as an output.

14. The apparatus of claim 13, wherein the apparatus is caused to:
process the LiDAR usage data to determine one or more of: (i) a number of LiDAR scans that have occurred at the one or more locations, (ii) a duration of LiDAR scans that have occurred at the one or more locations, or (iii) a number of the one or more mobile devices that have performed a LiDAR scan at the one or more locations; and
include the one or more locations in the map layer based on determining one or more of: (i) that the number of LiDAR scans is greater than a threshold number of LiDAR scans, (ii) that the duration of LiDAR scans is greater than a threshold duration of LiDAR scans, or (iii) that the number of the one or more mobile devices is greater than a threshold number of mobile devices.

15. The apparatus of claim 13, wherein the usage data relates to usage of the LiDAR for localization.

16. The apparatus of claim 13, wherein the apparatus is caused to:
process the LiDAR usage data to determine parameters including a date or time of LiDAR usage or scanning, a manufacturer, model, type, year, capabilities/features, a manufacturer of a LiDAR sensor used by the one or more devices, a model of the LiDAR sensor, a type of the LiDAR sensor, one or more capabilities or features of the LiDAR sensor, a manufacturer of the one or more devices, a model of the one or more devices, a type of the one or more devices, one or more capabilities or features of the one or more devices, a LiDAR-based localization success rate, a type of object detected by a LiDAR scan, a number of scans in a scanning session, a scanning orientation, a moving versus stationary LiDAR scan, contextual information of a scanning environment, or a combination thereof,
wherein the map layer further associates one or more of the parameters with the one or more locations.

17. The apparatus of claim 13, wherein the apparatus is caused to:
process the output to generate a user interface depicting a representation of the map layer.

18. A non-transitory computer-readable storage medium, carrying one or more sequences of one or more instructions which, when executed by one or more processors, cause an apparatus to at least perform the following steps:
determining Light Detection and Ranging (LiDAR) usage data generated by one or more mobile devices;
generating a map layer of a geographic database based on the LiDAR usage data, wherein the map layer indicates one or more locations where a LiDAR device was used by the one or more mobile devices based on the LiDAR usage data; and
providing the map layer as an output.

19. The non-transitory computer-readable storage medium of claim 18, wherein the apparatus is caused to further perform:
processing the LiDAR usage data to determine one or more of: (i) a number of LiDAR scans that have occurred at the one or more locations, (ii) a duration of LiDAR scans that have occurred at the one or more locations, or (iii) a number of the one or more mobile devices that have performed a LiDAR scan at the one or more locations; and
including the one or more locations in the map layer based on determining one or more of: (i) that the number of LiDAR scans is greater than a threshold number of LiDAR scans, (ii) that the duration of LiDAR scans is greater than a threshold duration of LiDAR scans, or (iii) that the number of the one or more mobile devices is greater than a threshold number of mobile devices.

20. The non-transitory computer-readable storage medium of claim 18, wherein the usage data relates to usage of the LiDAR for localization.
